(19) United States
(12) Patent Application Publication
(10) Pub. No.: US 2025/0231670 A1
(43) Pub. Date: Jul. 17, 2025

(54) Touchpad smart case

(71) Applicant: James Filomio, JR., Kansas City, MO (US)

(72) Inventor: James Filomio, JR., Kansas City, MO (US)

(21) Appl. No.: 18/211,697

(22) Filed: Jan. 11, 2024

(51) Int. Cl. G06F 3/04842; G06F 1/16; G06F 3/02; G06F 3/04812; G06F 3/0488; G06F 3/0489

(52) U.S. Cl. CPC G06F 3/04842; G06F 1/1626; G06F 3/0202; G06F 3/0227; G06F 3/04812; G06F 3/0488; G06F 3/0489

(57) ABSTRACT

A smart device that initiate graphical user interface(s) of that device, by use of a rear mounted touchpad, an on-screen cursor and clicker buttons. The cursor is moved over the front viewing screen by touchpad input. To initiate an action, the user positions the cursor over a graphical user interface, then pressed one or both clicker buttons. This device is designed to be used one handed.

### BACKGROUND OF INVENTION

The said invention is a smart device case designed so an electronic handheld ‘smart’ device can be operated one handed. The Touch Sensitive Pad, cursor, taskbar and mounted clicker button(s) initiate devices features of said device one handed. Input (touch) to the Touch Sensitive Pad initiates cursor movement on the front element screen. The Touch pad along with the clicker button(s) navigate the ‘smart’ device and initiate graphical user interface(s). The said invention may display physical buttons that control the (e.g., power) or one embodiment might have an on-off button graphical user interface.

The said invention incorporates a touchpad with one embodiment housing a center clicker button. One embodiment has a touchpad with no center clicker button and houses two clicker buttons housed in the side of the case between the front and rear housing. When the cursor is positioned over a graphical user interface, pressing a clicker button will initiate that application. The housing mounted clicker button(s) maybe also be held down to initiate (e.g. scrolling, highlighting and cut and paste).

The said invention incorporates an on-screen taskbar that allows for ‘swapping’ graphical user interface(s) for quicker use. The taskbar is the location where the on-screen cursor is housed when not in use. The case is placed over the rear of a smart device and mated to the device through Bluetooth connection. An application is then downloaded that initiates the on-screen cursor and task bar to appear on front viewing screen, The touchpad input will move the on-screen cursor over the front viewing element. Pressing the clicker button(s) will initiate the graphical user interface the cursor is over.

The touchpad is flat and not limited to color, the touch pad is not limited to shape.

The cursor is not limited to color.

The taskbar can be repositioned on the screen.

The mouse clicker buttons are snap action switch.

The clicker buttons work in sync unless changes are made in settings.

Cursor speed on viewing screen can be adjusted in device setting.

The touchpad is removeable from case to be used wirelessly.

### BRIEF SUMMARY OF INVENTION

The said invention incorporates a Touch Sensitive Pad an on-screen cursor on the front element of the handheld device, an on/off switch, either displaying a physical switch or an on-screen graphical user interface in the taskbar, either one or two snap action switches, or touchpad center clicker. The input (touch) to the touch sensitive pad initiates movement to the on-screen cursor on the touch screen element, controlling systems and features of the device. When a cursor position is achieved, meaning, positioning the cursor over a graphical user interface, one or both of the mouse clicker buttons are pressed to initiate that application, or in one embodiment the center touchpad clicker may be pressed. When the on-screen cursor is positioned over a graphical user interface, the graphical user interface is not limited to being highlighted.

The mouse clickers are used to achieve the same outcome. Both clickers are programed to the same measurements and code and pressed together achieve the same command as if one were pressed alone. This makes the device usable in either hand.

Advanced settings of the clicker buttons allow change in actions of the buttons, (e.g. allows one clicker button to only be used for scrolling, answering calls, pressing the ‘GO’ tab to execute a search command.) Factory settings allow clickers to act in the same manner.

### BRIEF DESCRIPTION OF SEVERAL VIEWS OF THE DRAWINGS

FIG. 1 of the drawings illustrates the front and rear view of the said case on the smart device. The rear view shows the force-sensitive touch surface (T) with built in clicker (mouse click). The on/off switch (B), that shuts off power to the touch surface. (R) is the case housing that mates the said invention case to the smart device and (C) is the camera. Also FIG. 1 illustrates the front view of the said invention with the smart device mated to the case. On the front view it illustrates the cursor (A) that is controlled by the user's finger movement on the force-sensitive touch surface (T), and is displayed in the device's display element. When the cursor (A) is positioned over the icon or command wanted, the user presses the force-sensitive touch surface (T) to activate the clicker, (aka the mouse click) and achieve the command given.

FIG. 2 of the drawings illustrates a rear view of the said invention and the user's hand position and movement on the force-sensitive touch surface (T) that controls the cursor (A) in the display element with movement.

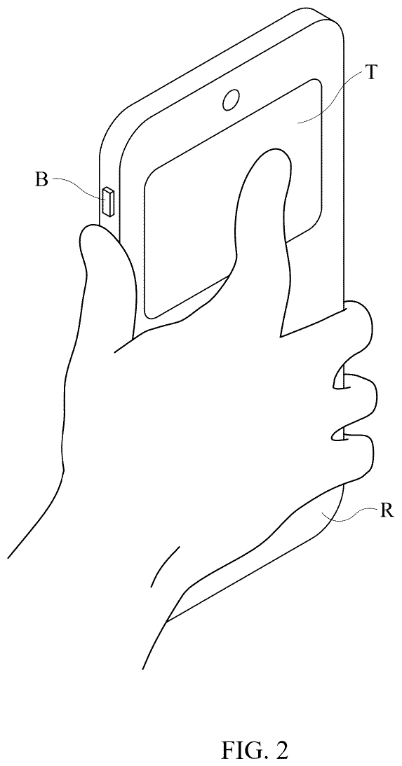

FIG. 3 of the drawings illustrates the front view of a smart device with the case installed. (J) illustrates the on-screen task bar. The task bar (J) is where the cursor is housed when not in use. The operator of the smart device can add and remove graphical user interface from the task bar. The task bar (J) is initiated through the application download Further, FIG. 3 illustrates (A) the on-screen cursor, and (X), (Z), which are side mounted clicker buttons.

### DETAILED DESCRIPTION OF THE INVENTION

The invention will now be described in detail with reference to a few specific details of the device, systems, patterns, but in no way should be intended to limit the disclosure to the described embodiments.

In electronics the definition of ‘Circuit’ or ‘Circuited’ follows as, ‘A configuration of electrically or electromagnetically connected components of devices’.

The schematic of the components of the invention are circuited to perform further actions below.

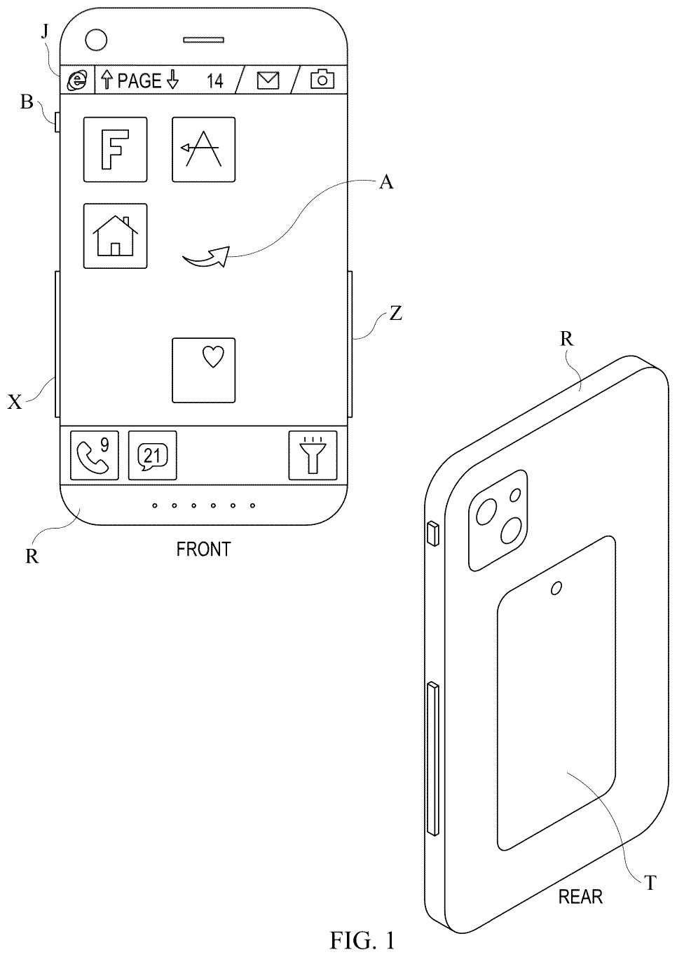

FIG. 1. Touch sensitive Pad (T) when case is mated to a smart device is located on opposite side of display element on a handheld electronic ‘smart’ device and is operated by input from (e.g. finger(s)) movements. Touch Sensitive Pad is not limited to size, shape or color and can be detached and attached to case. The touchpad housing supports the touchpad and the clicker buttons.

Touch Sensitive Pad (T) when manipulated by input (touch), will move the cursor (A) over front display element, and when cursor (A) is positioned over a graphical user interface pressing one or both ‘click buttons’ (X), (Z), or center clicker located in touchpad, will initiating the application.

FIG. 1. (B) Illustrates a power button for only Touch Pad, not the device. Turning button (B) ON, will activate Touch pad (T) and display on-screen cursor, further displaying on-screen task bar.

Cursor (A) is housed in on-screen Taskbar (J) when not in use. Pressing one or both clicker buttons (X), (Z) or center touchpad clicker will drop cursor (A) from taskbar (J).

Cursor (A) can be ‘swiped’ off front screen element by input (touch) over cursor and positioned back to the task bar (J), cursor icon display can be altered in the cursor information setting on the application.

In one embodiment, task bar (J) can be ‘removed’ off display screen by one press of Touch Pad's ON/OFF button, but is not limited to on-screen cursor (A) still being displayed and used.

Taskbar in one embodiment may be removed from front screen element by a graphical user interface, or not an option.

If task bar (J) has been removed from display screen, it can be returned back to display element by Touch Pad on/off button.

The design and location of Touch Sensitive Pad (T) on case, allows a smart device to be held and operated in any angle, (vertical or horizontal), so when the device is turned from vertical to horizontal, taskbar (J) and on-screen cursor (A) will adjust with the repositioning to remaining vertical.

Touch Sensitive Pad (T) is a multi-touch surface allowing, (e.g., zooming, realigning the display element, highlighting etc.).

The said invention is not limited to physical buttons or switches.

Input to touch pad (controls cursor movement) cursor (A), by touch movement on Touch Sensitive Pad (T), the movement and location of cursor (A) on front display element is determined by the touch, movement and location on Touch Sensitive Pad (T).

Input to touch pad, (touching, sliding), (e.g. index finger) against Touch Sensitive Pad (T) moves on-screen cursor (A) in accordance with movement against Touch Sensitive Pad.

Example of use, operator slides index finger across the rear touch pad from (bottom to top) positioning front on-screen cursor over graphical user interface (volume tab) in taskbar (J).

Example of use, operator slides index finger across rear touch pad (T) from (bottom to top), positioning front on-screen cursor (A) over graphical user interface (volume UP tab) in task bar (J), pressing clicker button (X) will initiate device's volume to rise.

Example of use, operator slides index finger across Touch pad (T) from (bottom to top), positioning front on-screen cursor (A) over graphical user interface (volume UP tab) in task bar (J), pressing clicker button (Z) will initiate device's volume to rise.

Example of use, operator slides index finger across touch pad (T) from (bottom to top), positioning front on-screen cursor (A) over graphical user interface (volume UP tab) in task bar (J), pressing both clicker buttons (X) and (Z) will perform the device's volume to rise.

Example of use, operator slides index finger across touch pad (T) from (bottom to top), positioning front on-screen cursor (A) to start of word document (job resume) file, pressing and holding down one or both clicker buttons (X), (Z) while sliding (e.g. index finger) down the surface of touch pad (T) will highlight the attended area.

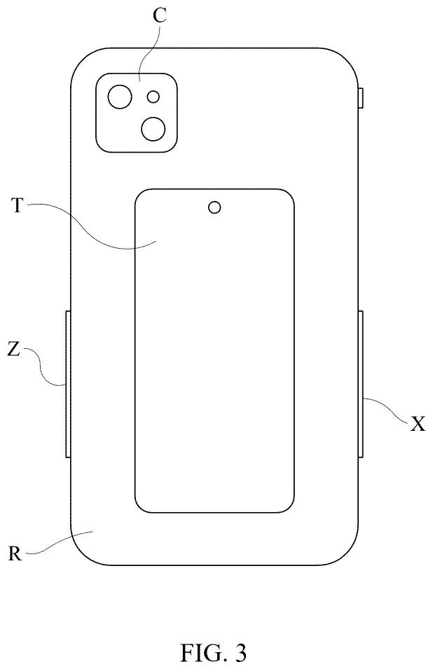

Example of use, the highlighted area (e.g. job resume) can be (copied) by pressing one or both clicker buttons (X), (Z) after operator slides (e.g. index finger) across touch pad (T) to position on-screen cursor over highlighted area, by pressing (e.g. clicker (X) FIG. 3) will display ‘smart’ device's task bar for (copy, paste, cut), input to touch pad relocates front on-screen cursor over (COPY) tab, pressing (e.g. clicker button (X)) over the selected tab (COPY), the text will be copied.

Example of use, operator slides index finger across touch pad (T) from (left to right), positioning front on-screen cursor (A) over graphical user interface (e.g. ‘PURCHASE’) tab on an ‘online store’, pressing clicker located on touchpad with initiate the ‘purchase’.

Example of use, operator slides index finger across touch pad (T) from (right to left), positioning front on-screen cursor (A) over graphical user interface (search bar), pressing one or both (Z) (X) clicker buttons will add a ‘text symbol’ (e.g. blinking blue line) to the search bar for starting text or type.

Input to the touch pad and input to the front touch screen can be used simultaneously.

Example of use, operator slides e.g. (index finger) across touch pad from left top, diagonally downward stopping on-screen cursor at graphical user interface icon banking app highlighting the icon, pressing one or both of the (clicker buttons) initiates banking application to active (open).

Example of use, after banking application opens and company's window (page) comes to view on front screen element, cursor doesn't leave the screen.

Example of use, ON/OFF button (B), will activate touch pad (T), cursor (A) and taskbar (J). Moving (e.g. sliding) power button (B) when the button is ‘ON’ will turn power to touch pad (T) ‘OFF’, removing the cursor (A) and task bar (J) from the front element.

Power button (B) is not limited to design.

Power button (B) is not limited to type of switch, (e.g. press button, switch or soft key), one embodiment, the soft key is not limited to switching the touchpad from a cursor controller to a page scroller.

Power button(s) are not limited to two switches.

Example of use, power on device with power switch or tapping front on-screen element, then active touch pad (T) cursor (A) and taskbar (J) sliding separate power button (B) to on. Pressing one or both clicker buttons (Z), (X) or in one embodiment, pressing the center touchpad clicker button will drop cursor (A) from taskbar (J) onto front screen element.

Example of use, with device main power ‘ON’ touch pad (T) switch may be turned off and device used by the front touch screen element only.

Powering off device main power switch will turn off Touch Pad circuit.

In one embodiment Turning ‘ON’ device main power switch will NOT turn on touch pad (T). Touch Pad (T), cursor (A) and taskbar (J) are circuited with a separate ‘ON’ power switch. Turning ‘OFF’ main power switch WILL turn off touch pad (T), cursor (A) and Taskbar (J).

Example of use, settings adjustment are not limited to, main power switch turning ‘ON’ touch pad.

Task bar (J) can be moved to any location on the front screen element by, positioning the onscreen cursor (A) over the taskbar (J), pressing and holding either or both clicker buttons (X), (Z), input to touch pad will move the taskbar (J) in the direction of input to touch pad. To release the taskbar (J) to a desired position, release the pressed clicker button(s).

Pressing either clicker button (X), (Z) may produce a sound. The sound of the pressing of a clicker button could be controlled in settings.

Clicker button(s) (X), (Z), cursor (A) and touch pad (T) initiate graphical user interface feature of the device that the front touch screen and input (touch) could accomplish.

Touch Sensitive Pad (T) is not limited to having a center clicker button.

Example of use, holding device in one hand can initiate systems and applications of device. Turn on device. Turn touchpad on with button (B). Pressing (e.g. clicker button (Z)) drops cursor (A) from task bar (J). Input to touch pad (T) moves cursor (A) on front screen element. Input on touch pad (T) to guide front element cursor (A) over (e.g. photos graphical user interface icon). When cursor is positioned over photo icon, pressing (e.g. center clicker button in touch pad surface) initiating application to view photos. To scroll, pressing and holding down (e.g. clicker button while input to touch pad (T) is initiated from top to bottom or bottom to top on touch pad surface.

One embodiment for scrolling, positioning cursor (A) over task bar (J) and over symbol for scroll down graphical user interface in taskbar (J). When cursor is positioned over down symbol, pressing (e.g. clicker button (Z)) and page will begin to move, to stop page movement release pressed clicker button (Z).

Cursor is not limited to color or design.

Touch pad surface is not limited to color, shape or design and is detachable from case.

Touch pad is not limited to shape, and can be detached and attached to case, the housing to the touchpad houses the clicker button(s) and are mated together for removal and attachment to case. The touchpad housing also houses the clicker button(s).

Clicker button(s) are snap action switches.

Example of use, the speed of the cursor on viewing screen is adjustable to preference. Example of one embodiment, a slow sliding input across touch pad from left to right drags the cursor from left to right on viewing screen at the same pace of input on touch pad.

Example of use, in one embodiment, a slow sliding input a cross-touch pad from left to right, drags the cursor across viewing screen at a rate of 2× as fast as input a cross-touch pad.

Cursor speed preference are adjusted in device settings on a sliding scale.

Example of one embodiment, the said smart case device is initiated or mated to a device (e.g. smart phone) with a downloaded application on the smart device (e.g. smart Phone), or Bluetooth.

The said smart case device attaches to a smart device (e.g. smart phone) by sliding over the rear facing side of a smart device, the touchpad housing can be removed or detached from case to be used wirelessly.

The said smart case device is powered in one embodiment by a battery.

The said smart case device in one embodiment is powered by wireless connection (Bluetooth) from smart device (e.g. smart phone).

1. An electronic smart device, comprising:
a case that mates to said electronic smart device comprising:
a display element cursor;
a touch sensitive pad; said touch sensitive pad having either a center clicker button or two clicker buttons housed on a side of said case;
two snap action switches, (clicker buttons);
a display element graphical user interface taskbar;
power switches;
a housing;
wherein said electronic smart device is Bluetooth compatible.

2. (canceled)

3. (canceled)

4. (canceled)

5. (canceled)

6. (canceled)

7. (canceled)

8. (canceled)

9. (canceled)

10. (canceled)

11. (canceled).

12. (canceled)

13. (canceled)

14. (canceled)

15. (canceled)

16. (canceled)

17. (canceled)

18. (canceled)

19. (canceled)

20. (canceled)

21. (canceled)
